(19) United States
(12) Patent Application Publication
(10) Pub. No.: US 2011/0302390 A1
(43) Pub. Date: Dec. 8, 2011

(54) SYSTEMS AND METHODS FOR PROCESSING COMMUNICATIONS SIGNALS fUSING PARALLEL PROCESSING

(76) Inventors: Greg Copeland, Plano, TX (US); Shehrzad Qureshi, Palo Alto, CA (US)

(21) Appl. No.: 12/794,725

(22) Filed: Jun. 5, 2010

(51) Int. Cl. G06F 15/76

(52) U.S. Cl. 712/2

(57) ABSTRACT

Systems and methods for performing processing of communications signals on multi-processor architectures. The system consists of a digital interface that translate numbers that represent a waveform in some format to analog signals for use in transmission and translating analog signals to numbers representing those waveforms in some format that can be processed by the commodity digital hardware and software combination. The digital hardware and software incorporates parallel hardware and software that can process single or multiple streams and multiple processing steps as required for the communications system in any combination. In the examples, the use of general purpose graphics processing units (GPGPUs) is illustrated, but the system is not necessarily limited to such an implementation. The system is highly scalable and modular for addressing a wide range of radio requirements, preferably using commodity components.

### TECHNICAL FIELD OF THE INVENTION

The invention relates to programmable processing methods and systems for use in communications applications. More particularly, the invention relates to performing communications processing functions on programmable parallel processors.

### BACKGROUND OF THE INVENTION

Generally the modulation and demodulation required in modern communications devices uses many different processing steps to convert data (digital or analog or other information that can be expressed in digital form) to a waveform signal used at the transmitter and conveyed by some means to a receiver that is tolerant of channel impairments and path losses between the transmitter and receiver. High performance communication systems are known to be very processing intensive. In the prior art these processing steps were performed with dedicated hardware developed specifically for that purpose. More recently, it has become known to partition off some of the processing steps, assigning different functions to individual processors such as programmable Digital Signal Processors (DSPs), Application Specific Integrated Circuits (ASICs) and/or Field Programmable Gate Array (FPGA) devices. This type of architecture is ad-hoc, has limited flexibility after the partitioning has occurred and has been committed to hardware, and is specific to the modulation format. The inflexibility inherent in these ad-hoc designs has been a major impediment to the development of a Software Defined Radio (SDR).

From efforts to make hardware more flexible for different applications and standards, the concept of the Software Defined Radio (SDR) arose. The SDR implementations to date have not fully realized the potential or vision of fully programmable hardware/software architecture. Providing the flexibility in hardware to the degree required for future modulation schemes and other foreseeable requirements undefined at the time of design has been nearly impossible. Difficulties in approaching these ideal goals are further compounded by the very short real-time schedules for the processing required in most applications. On the one hand, making the software more portable and structured degrades performance, which has been a limitation in the application of the SDR concept. On the other hand, performing many of the functions in FPGAs provides some flexibility with good performance when using FPGAs that have downloadable codes from a host processor, but this approach requires much more effort to develop than pure software and imposes a time-to-market limitation, and imposes yet more design restrictions. Each implementation has limited reuse potential, such that nearly every change in waveform calls for a complete new design. Also, FPGA implementations tend to have higher power and cost compared to full ASIC implementations. There have been base stations introduced to the market claiming SDR functionality, but the portability and performance of SDR systems known in the art are limited. The designs current in the art use a combination of DSPs and field-programmable FPGAs that limit design flexibility and limit development cost reductions attainable.

Due to the foregoing and possibly additional problems, improved methods and systems for processing communications signals using parallel processing systems and techniques would be a useful contribution to the arts.

### SUMMARY OF THE INVENTION

The invention provides systems and methods for digitally modulating and demodulating communication signals using parallel processing. The invention may be used for the purpose of transforming bit streams or other information that can be represented as a sequence of numbers into waveforms for transmission and receiving on a communication channel, and processing them to extract the information stream using a plurality of processing elements in the described architecture. For example, the invention may be used to enable mobile phones or other mobile devices to communicate with a network access point or base station. The systems and methods may also be used for signal processing within a network access point or base station. Scalability potential is also provided for large scale communications processing solutions.

According to one aspect of the invention, in a preferred embodiment of a communications processing system, a plurality of functionally identical processing elements are interconnected by shared memory interfaces. The shared memory is coupled with a host General Purpose Processor (GPP) for communications and/or control of the processing elements. Each of the processing elements is connected to a local private memory, increasing total memory bandwidth for the processing elements. A digital interface to one or more antennas is also provided.

According to other aspects of the invention, in an example of a preferred embodiment, a communications processing system includes processors for performing computations used for one or more processing functions, including dynamic spectrum awareness for spectrum allocation optimization, computing metrics for routing decisions between wireless nodes, utilizing multiple antenna resources for improved performance, computing metrics for improved system performance with multiple base stations.

According to another aspect of the invention, a communication signal processing system in a preferred embodiment includes numerous processor elements. Each of the processor elements has local memory and an arithmetic unit, an interface for communications, and a control block that may control individual processing elements or clusters of processing elements. One or more devices provide communication between the processor elements. A host processor is provided for programming and controlling the processor elements, and an interface with one or more antennas completes the system.

According to additional aspects of the invention, in exemplary embodiments, a processing system is disclosed in which at least one GPP using an operating system is coupled with at least one General Purpose Graphics Processing Unit (GPGPU) for communications processing, an interface to at least one radio resource, and an interface to at least one communications network. The system may include a GPP and its operating system configured in such a way as to establish virtual machines for partitioning services in various ways according to operational parameters and/or service objectives.

### BRIEF DESCRIPTION OF THE DRAWINGS

The invention may be understood from the following detailed description when read in connection with the following figures:

FIG. 1 (PRIOR ART) is a block diagram of a base station with a remote radio head (RRH);

FIG. 2 is a functional block diagram of an example of processing partitioning according to a preferred embodiment of the invention;

FIG. 3 is an illustration of an exemplary remote radio head (RRH) in an example of a preferred embodiment of the invention;

FIG. 4 is a block diagram of an implementation of a processing subsystem in a further example of an alternative embodiment of the invention;

FIG. 5 is a block diagram of a clustered version of a processing subsystem in an example of a preferred embodiment of the invention;

FIG. 6 is block diagram of a system and method utilizing multiple remote radio heads (RRHs) and towers in a representative implementation of preferred embodiments of the invention;

FIG. 7 is an exemplary transmit processing chain in an example of a preferred embodiment of the invention; and

FIG. 8 is an exemplary receiver processing chain in an example of a preferred embodiment of the invention.

References in the detailed description correspond to like references in the various drawings unless otherwise noted. Descriptive and directional terms used in the written description such as front, back, top, bottom, et cetera, refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DETAILED DESCRIPTION OF THE INVENTION

Communication applications require and will continue to require increasing amounts of data to be transmitted over wireless systems. Systems and methods are disclosed that provide very flexible communications capabilities wherein the hardware is scalable and supportive of communication approaches known in the arts and is designed to support future modifications. Preferably, communication is accomplished using a selection from among several known protocols for voice and/or data transmission, for example, CDMA, WCDMA, TDMA, GSM, EDGE, 3G, 4G, LTE, WiMax, 802.16e, 802.11b, 802.11g, Bluetooth, Zigbee, WLAN, WPAN, WWAN, and the like. The invention is not limited to these modulation and demodulation methods. The individual communication devices may be cell phones or other devices, including wireless portable email terminals, computers, both fixed and portable, such as laptops and palm computers, smart phones, fixed location, handheld, and vehicle mounted telephone equipment, personal internet browsing devices, video equipment, and other communications or data receiver or transmitter applications. In these exemplary applications, and potentially others, all of the necessary communication processing is preferably performed using the standard hardware architecture described. An advantage of the approach is that nearly any communications standard or method can be implemented on a low-cost, high-performance commodity hardware platform. This allows easy field upgrades and standard changeover as required to upgrade systems for performance or standards reasons. Additionally, multiple standards may be supported simultaneously on the same platform and/or multiple service providers may share the same hardware resource for more cost effective solutions. Also, the architecture components are commonly available components so that costs may be reduced by using components also used in other high volume industries. Further advantages include one or more of: general programmability, reduced development costs; rapid remote field upgrades and waveform modes for rapid upgrades without physical investment; partitionable processing, accommodating multiple standards, operators, and virtual base stations simultaneously; accommodating developing standards without hardware changeover; scalable architecture where only new processing elements need to be added for additional performance; parallel processing reduces latency; utilizes readily available low-cost, high-performance interconnect and switching hardware for scaling using Infiniband or similar technologies across multiple processing blocks. In general, the invention provides communication signal processing using an implementation of parallel processing, preferably massively parallel processing. The processing systems and methods preferably use readily available components, maintain the required performance, and are sufficiently programmable and adaptable to reduce the investment required to implement many existing standards and future modifications. The system and methods described herein may be embodied in other specific forms without departing from the spirit or essential characteristics thereof. The described embodiments are therefore to be considered in all respects illustrative and not limiting. The invention described is one potential implementation of a software defined radio (SDR).

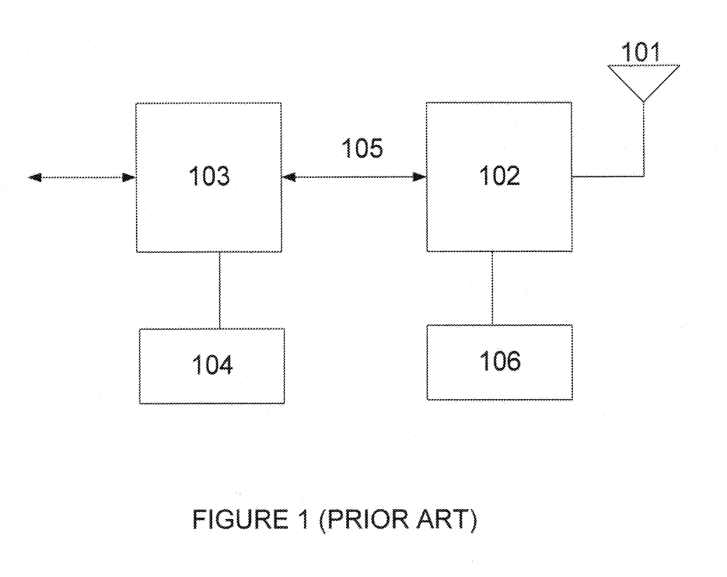

FIG. 1 (PRIOR ART) depicts a simplified schematic of a radio system illustrating Radio Frequency (RF) modulation and demodulation and the signal processing used to convert from information sources to the RF interface and back to the original information format as required by the communication system. In this block diagram representing a common base station, an antenna 101 is connected to a Remote Radio Head (RRH) 102 that up-converts digital data for transmission and down-converts RF and digitizes the data for consumption by the base station 103 using a communications link 105. The interface to the RRH 102 is typically OBSAI (Open Base Station Architecture Initiative), CPRI (Common Public Radio Interface) however other interfaces may be adopted for this used such as Infiniband, SRIO, Ethernet, or other suitable method. The RRH may have multiple antennas for MIMO (Multiple Input Multiple Output) operation and typically there is one RRH per sector supported. The base station 103 is in turn connected to the back haul network using a suitable communication link 106. Additionally, the system typically includes power, air conditioning, and perhaps other infrastructure 104, and a clock reference 107 with sufficient accuracy to perform the communications functions required.

A GPGPU as used in preferred implementations of the invention is a processing system that may include a plurality of processing elements interconnected by shared memory interfaces, a shared memory connected to a host general purpose processor (GPP) for control of the shared memory. Each processing element is connected to a local memory to increase total memory bandwidth for processing. The processing system efficiently performs communications processing. The GPGPUs are preferably massively parallel with hundreds or thousands of processors. This changes the processing paradigm of the processing model. Each processing element may be a vector processor using a single instruction stream with a separate data stream for each element. One or more devices are included for providing communication between the processor elements. A host processor is utilized for programming and controlling the processor elements. Each processor element has local memory, and the processor elements may each perform communications signal processing.

An example of a preferred implementation of the methods and systems of the invention is described with respect to use in the context of wideband cellular, i.e., wireless, communications, but the invention is not is not limited to such applications. A typical exemplary application considered is for a cellular telephone base station and data access point. Graphics Processor Units (GPUs) have been generalized to address a wider range of applications beyond computer graphics and have sometimes been renamed General Purpose Graphics Processor Units (GPGPUs). These processors have been applied to many traditional high performance computing applications, such as, not surprisingly, graphics processing. It has been noted by the inventors that these processors to date have not been applied to communications. Modern GPGPUs offer floating point arithmetic, reducing the engineering effort in the implementation of many algorithms. They also support fixed point arithmetic so that algorithms may utilize this capability for higher speed processing where deemed feasible or to ease the porting of software already using fixed point arithmetic. Examples of communications functions that may be provided according to the invention include but are not limited to: channelizer/polyphase filters; equalization filters; Fast Fourier Transforms/Inverse Fourier Transforms (FFT/IFFT); forward error correction (FEC) encoding and decoding (where the code may include convolutional codes, LDPC codes, Turbo Codes, Algebraic codes); interleaving/de-interleaving; matched filtering; numerically controlled oscillator/quadrature mixers, Automatic Gain Control (AGC); clock/carrier recovery; CDMA spreading/dispreading; rake receiver; sample rate conversion; preamble insertion/removal; preamble correlations; generation of quality metrics (such as EVM and ACLR for example). According to the invention, all of these functions may be performed with GPGPUs or similar processors. The processors may also be used for higher layer processing required in a complete communications system such as a base station. One example is the mapping of MAC addresses to IP addresses. This mapping can be significantly accelerated on a parallel or massively parallel processing architecture, as in a GPGPU, by assigning a search range to each processing element and then collecting the information in a central point with the ‘winning’ processor reporting the match found. Distributed algorithms may also be used for routing, using a distributed Dijkstra algorithm as an example. Alternatively, the L2/L3 functionality may be provided using multi-core microprocessors.

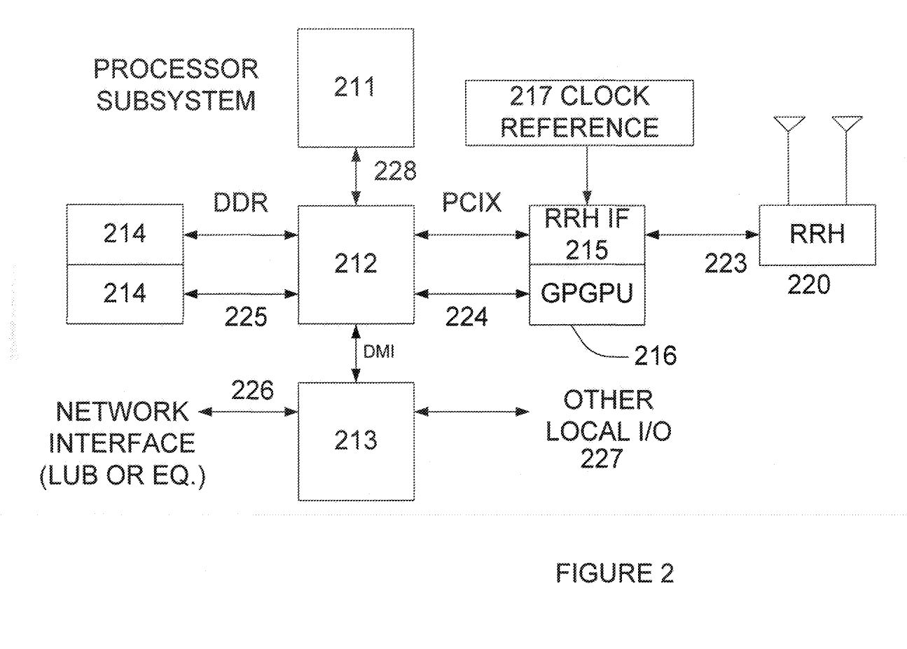

In FIG. 2, a block diagram of the basic signal processing performed in a base station or mobile device according to the invention is shown. This block diagram is given as exemplary of a typical implementation. Many variations are possible without departure from the principles of the invention. In the case of a mobile device, the RRH 220 function is preferably provided with an RF ASIC that is co-located with the other processing functions. The processing subsystem includes a GPP 211, connected to a memory controller 212 via a memory communications link 228. An external memory 214 is connected to the memory controller using a suitable link 225. An IO controller 213 is provided for lower speed devices 227. A digital baseband RF interface 223 is connected to the RRH 220, and a GPGPU 216 is connected to the memory controller 212 as shown by arrow 224. In operation, the GPGPU 216 provides most of the signal processing required to transform the digital baseband information to decoded bits. The control and programming of the GPGPU 216 is provided by a General Purpose Processor (GPP) 211. The other elements generally required for support of these functions may be integrated into other elements of the subsystem. The clock reference 217 provides accurate timing for communication with a target receiver. This timing may be transferred to the RRH using the link bit clock. The base band data to and from the GPGPU may flow directly from the RRH through a data switch into the GPGPU and into the GPP or the data from the RRH may flow into a memory 214 and then moved to and from the GPGPU using either direct GPP instructions or DMA (direct memory access).

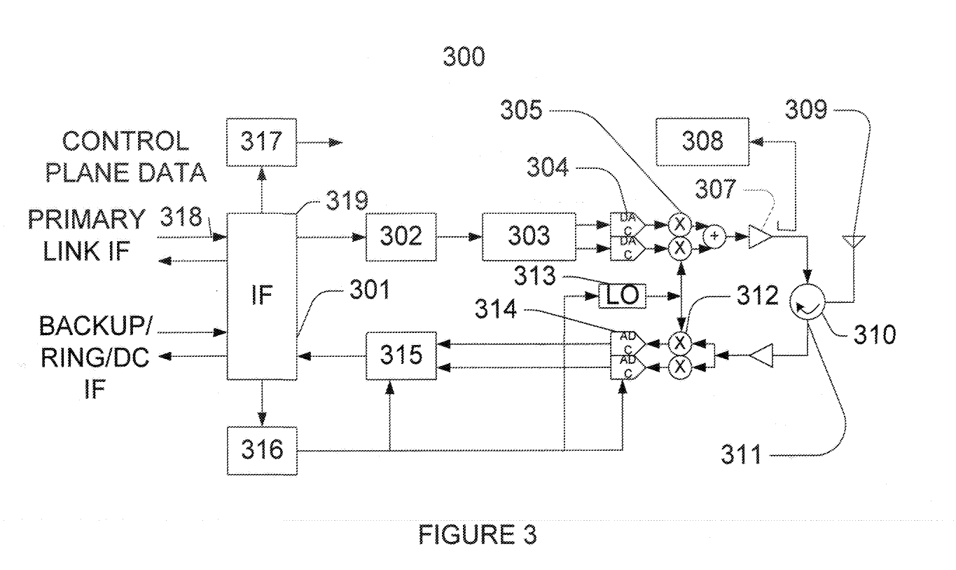

FIG. 3 provides an overview of an exemplary implementation of the RRH 300 as required by the base band processing subsystem. There are many other potential implementations. The functions of the RRH 300 may include: accept base band samples from the signal processor link 318; convert the base band samples to an analog waveform(s) using a DAC (digital to analog converter) 304; frequency convert the analog base band signal to the desired RF carrier 305; amplify the RF information 307; apply the RF waveform and antennas switch, circulator, or duplexer 310; and apply the resulting signal to an antenna or a plurality of antennas 309; receive waveforms from the antenna; receive signal is applied to an RF switch, duplexer or circulator 310; amplify the receive waveform 311; down-convert the analog waveform(s) 312; digitize the received waveform(s) using an ADC (analog to digital converter) 314; filter and decimate the received waveform(s) 315; format the data for transmission 301; and send the data over an interface link 318 to the signal processor; extract control information and apply the control to the radio path as desired; monitor performance and other operational metrics and report over the link control path; extract timing information and distribute the elements requiring clock information. The RRH 300 has a digital interface to the processing subsystem using a link 318, to an interface block 301 that extracts the data into the necessary streams and assembles the streams for transmission back to the processing subsystem. Typically the data is up-sampled and filtered using a digital up-converter 302 followed by Crest Factor Reduction (CFR) followed by digital predistortion (DPD) processing 303. The output of the DPD 303 is then passed to digital-to-analog converters 304, heterodyned to RF using mixers 305, and then amplified with an RF power amplifier 307. For DPD processing, usually a feedback path is preferred 308, that samples the power amplifier output and is then fed to the processor for adaptation of the DPD parameters to minimize the power amplifier distortion. The output of the amplifier 307 is fed either to an RF switch, circulator 310, or to one or more antenna 309 for transmission. The received signal is then amplified using a low noise amplifier 311, down-converted by a mixer 312, and digitized using analog-to-digital converters 314. The digital samples are then further filtered and decimated using a digital down-converter 315 and then transmitted back to the processing subsystem using the link 318. Additionally, a clock 316 may be derived from the link bit clock and used to synthesize the frequencies used in the digital processing, Local Oscillator (LO) 313 and data converters. The RRH 300 shown and described is exemplary only. No other specific requirements are placed on the RRH for the practice of the invention other than the capability for interfacing sample data to the antenna(s). Other features and processing that may also be provided may include analog filtering, amplification, modification or other processing required to meet system requirements at the analog level.

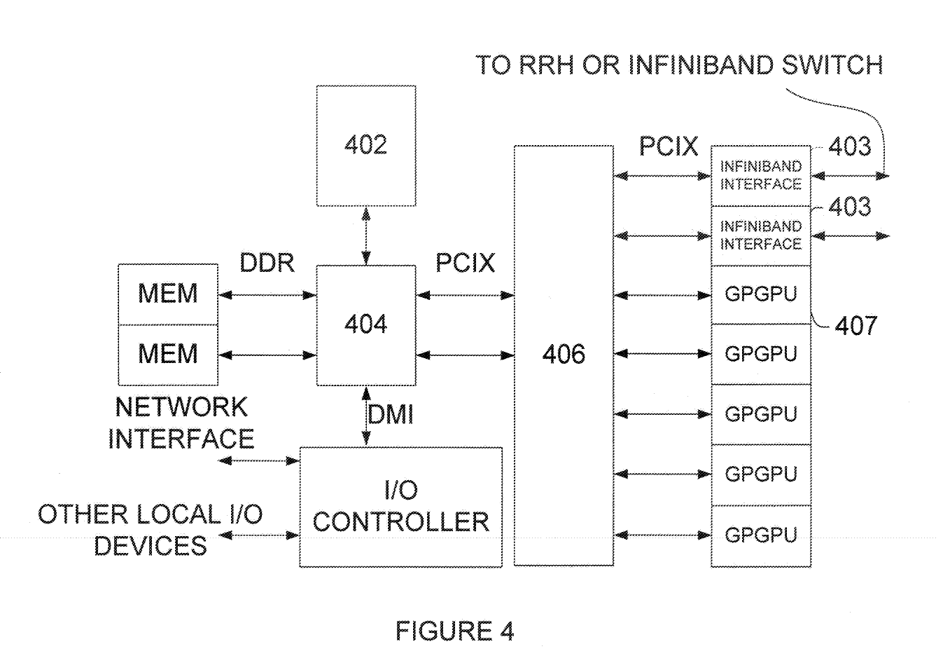

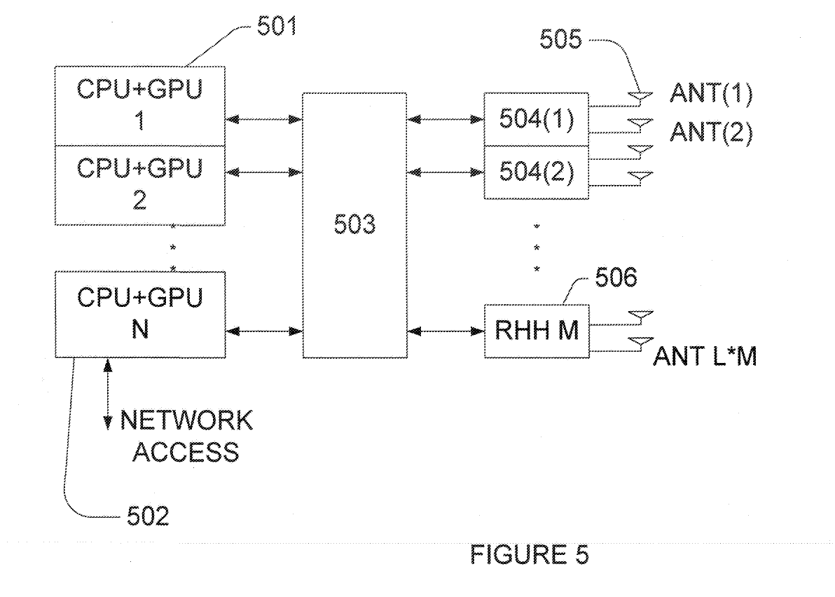

In some applications more processing will be required than can be provided by a single GPGPU. Now referring primarily to FIG. 4, it is illustrated that expansion of the processing performance may be implemented using multiple GPGPUs 407. Using multiple parallel GPGPUs, the workload may be apportioned, for example with each of a plurality of GPGPUs processing the data associated with: a subset of the users; a virtual base station (BTS) with each service provider using a subset the available GPGPUs; data from a subset of the antennas; or a combination from the above. In some applications, a single powerful GPGPU may be adequate for the worst-case operating scenario. In this environment, the GPGPU may be partitioned either among users or communication channels. The allocation of GPGPUs to the work required may be dynamic in that each GPGPU may be considered a virtual resource that can be assigned to particular tasks based on the dynamic processing requirements and the availability of processing hardware resources to maximize the processing efficiency. Each GPGPU preferably has multiple processing resources that are independent, so each of these computing resources can be pooled from a single GPGPU or across the array of GPGPUs computing resources available. The host GPP 402 coordinates the processing across the processing resources available. With modern processors having multiple cores or GPP in a single device, these resources can also be pooled. The other elements shown in FIG. 4 are similar to those introduced in FIG. 2. Additional RRH interfaces 403 may also be provided for redundancy, for ring topologies to the RRH, or to directly support multiple RRHs. A data switch 406 is used to connect the components in the processing subsystem as may be desirable in a particular implementation. The result is to increase processing capabilities by using a switch fabric to interconnect the processing elements. It should be appreciated that redundancy capability is inherently supported in the architecture where multiple GPGPUs and GPP processors are available. Also preferably attached to a PCIe (PCI express) switch 406 are multiple RRH interfaces. These multiple interfaces may be used to: support multiple RRH devices; provide redundancy as a simple dual link to a single RRH; provide redundancy by interconnecting the RRH devices in a ring topology. If more processing is desired in a single location, the architecture may be further expanded using multiple processing subsystems 501 interconnected as illustrated in FIG. 5. In this configuration, multiple processing subsystems may communicate to multiple RRH devices 504 through a communications switch 503. The portioning and load balancing may be done essentially as outlined herein for the case where a single physical processing subsystem possesses multiple resources. Through this portioning and expansion paradigm, the processing can be scaled to any level required for the implementation.

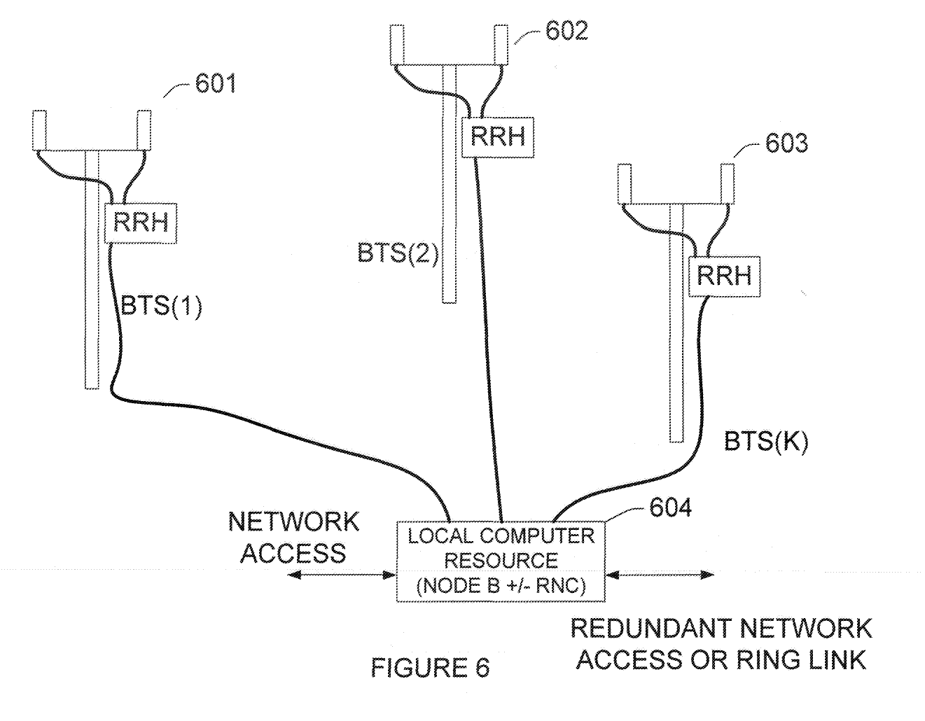

In the example of virtualization of a base station, each service provider may be given a physical GPP resource, and the GPGPU processing may be managed in the host processor. However, despite some reduction in performance, it may be preferred for the GPP pool to use the virtual processor pool so that the system can benefit from this approach. The GPPs may be allocated based the virtual processing load, for example, where a specific vendor requires a portion of a GPP or several across the array. The system then also benefits in that redundancy may be built into the operation of the system so that failed units can be reported and the work dynamically reassigned to functional units. Consider the application illustrated in FIG. 6. In the case where fiber or other communications methods to RRHs, e.g., 605, 606, 607, can be committed over a physical region requiring multiple BTS nodes, the more efficient method of providing the service would be to consolidate the processing into a central processing node 604 servicing multiple BTS antenna arrays, 601, 602, 603. The processing costs may then be reduced by reducing the infrastructure requirements, balancing work loads over more processing resources gaining statistical multiplexing gains, and providing a greater level of redundancy for the system.

The processing may be distributed to accommodate processing loads that are not feasible with the current state of the art in a number of different ways or some combination of ways. The processing loads may be split using at least one of the following.
a) Sectors—Most base stations use 2 or 3 sectors that are mostly independent and therefore the processing may be easily partitioned such that the processing elements may process data from a subset of the supported sectors. Generally most sectors are served with a single RRH that may have a single or a plurality of antennas attached.
b) Users—In many wireless standards there is a common front end that is split between different uses in the processing chain using one of or a combination of frequency slots, time slots or spreading codes. The common processing may reside on one computing resource and different users or subsets of users may be split between multiple processing resources.
c) Service providers—One platform may be suitable to provide processing required for multiple service providers. Each service provider may be assigned a virtual machine for separation of processing and protection of data. The number of service providers supported at a given site may vary with each service provider consuming one or multiple processing machines or multiple service providers may share a single processing resource.
d) Processing functions—In the processing chain there are multiple processing steps required to complete the base station functionality. These functions may be processed by a single processing resource or allocated among several processing resources.
e) Radio Standards—Multiple radio standards may be supported on the platform allowing a more efficient solution rather than using hardware and software developed for a specific standard. Each radio standard may be processed on a single or a plurality of processing resources and RRH elements.

In all of these cases, the resources may be statically or dynamically allocated in any combination. Static allocations are the simplest but may not be the most efficient use of the processing resources. Dynamic allocation utilizes the resources more efficiently but an overhead is incurred in the allocation of the resources.

In the shared resource model many resources may be deployed for the implementation of the base station. With multiple processing modules or multiple RRH's the system may include a switching fabric to route data between resources for load balancing. The introduction of a switching fabric allows the base station to be scaled to nearly any size as may be required.

With the possibility of supporting multiple service providers on a single platform, the base station may be provided as a service itself to a cellular service provider or an agent of the service provider. These services may be one of the following, or a combination of the following.
a) Software as a Service (SaaS)—the software required to provide the necessary functionality of a base station is provided under some method of remuneration. The entire service is provided as it pertains to the base station.
b) Platform as a Service (PaaS)—the platform includes the processing resources and the RRH resources with a minimal set of software that includes the operating system. The entire platform is provided under some method of remuneration.
c) Infrastructure as a Service (IaaS)—A platform where virtualization is provided so that each service provider has an application that is logically separate from other clients in the processing platform.

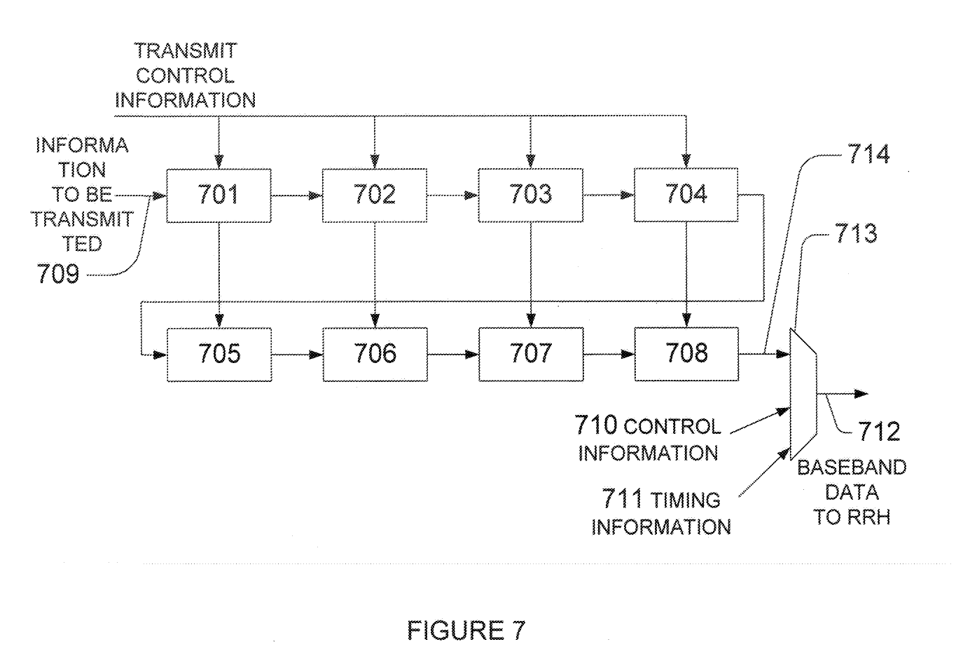

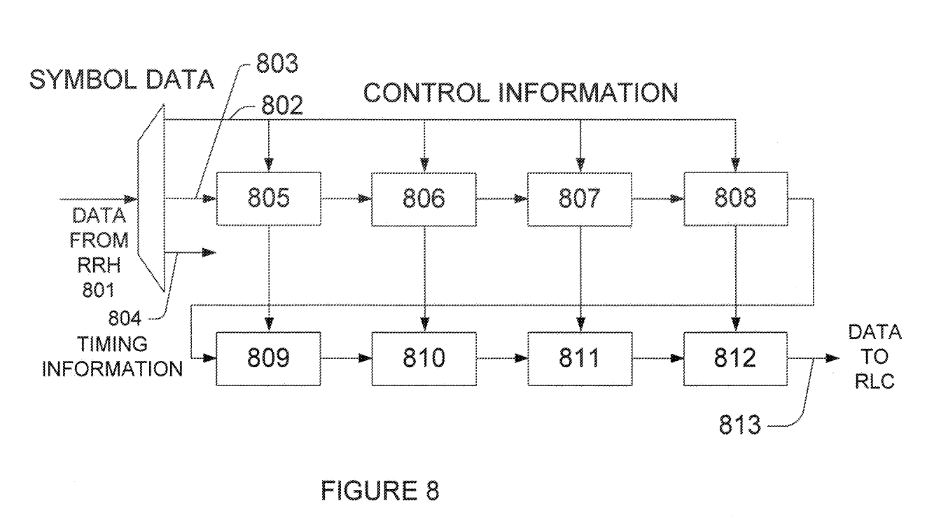

An exemplary processing flow used in the signal processing of the transmission path is shown in FIG. 7. This illustration is for discussion purposes and the actual processing functions provided may vary from one application to another and multiple processing elements may coexist simultaneously on the same processing platform depending on the specific requirements either at the time of implementation or as assigned dynamically during operation as the processing loads and types vary over time. As shown in functional blocks 701-708, information to be transmitted 709 may be processed using selected transmit control information. Input data formatting and buffering functions 701 are provided, followed by encoding of the buffered data according to selected operation requirements such as priority, e.g., CRC/L2 FEC encoding 702, and/or L1 FEC encoding, box 703. Data is further prepared for transmission by the insertion of the necessary preamble or other formatting information 704, interleaving 705, MIMO processing 706, modulation 707, and filtering 708, according to the specific requirements for a particular implementation. In the In general, the data from the radio link control (RLC) 709 is accepted for processing as well as meta-data indicating the type of processing desired, including the parameters for the processing. This meta-data may completely describe the entire processing chain and through this interface the processing required for a specific standard may be described. For example, WiMAX, WiFi, CDMA, or other standards may be used. In the assembly of the data presented to the data link to the RRH 712, multiple data types are multiplexed using the logical multiplexer 713 which accepts symbol data or equivalent 714, control information 710, and timing information 711. The multiplexing of the control information may in part or in whole be meta-data that is passed through the processing chain to be used at the RRH. The timing information may have time stamps that indicate the time of transmission associated with the symbol data presented to the RRH and/or time stamps on the received data to indicate the time of arrival of the received symbols. In FIG. 8, the complementary receiver processing chain is shown in an exemplary implementation, which is of course not limited to the specific processing indicated. The data from the RRH 801 is demultiplexed into multiple logical streams having control information 802, symbol data 803, and timing information 804. The control information 802 may be used to select the processing steps required, e.g., 805-812, for extracting the information preferred for the RLC (Radio Link Control). The control information may be augmented to select the processing for vendor specific processing requirements, modulation/standard implementation, RRH or antenna source, virtual BTS associations, and/or processor associations. In the input buffering, the data 803 is queued for processing and prioritized based on the performance requirements, SLA (Service Level Agreement), QoS (Quality of Service), or other parameters and placed into a processing queue 805. In the example, processing chain filtering and application of frequency translation using a Filter, NCO (Numerically Controlled Oscillator) and quadrature mixer 806 is performed on a GPGPU resource as a thread. Next, a correlation is performed 807, and time alignment is made relative to the timing information 804. After time alignment is obtained, the preambles and pilots may be removed 808 in a GPGPU thread, and queued for the next processing block. These processing steps are preferably scheduled on the GPGPU, using processing blocks shown at reference numerals 809-812. After the radio layer processing is completed, the data 813 is presented to the RLC or equivalent as mandated by the communications standard employed for this instance of the processing chain.

In general, a system that uses a plurality of parallel processors for providing a plurality of functions required in a high performance system for waveform processing may include a plurality of functions, which are parameterized such that the required processing steps are partitioned among a plurality of processing elements. The plurality of functions have inputs, outputs, and parameters in accordance with a common protocol such that the processing functions and control functions are separated along these lines. A hierarchy of communications methods between processors, and groups of parallel processors that is efficient for the functions considered may also include multi-ported memories or switch fabrics. The processing functions of the system can be scheduled in any order using the common interface rules in any order to accomplish the system function desired. The processing elements or blocks may process vectors using a SIMD or SIMT (single instruction multiple thread) architecture and may contain multiple SIMD/SIMT blocks. The processing system may be connected to a plurality of antenna elements to facilitate MIMO operation, multiple virtual base stations, multiple service providers, or multiple radio standards simultaneously or in any combination thereof. The system work load may be partitioned by radio standard, service provider, antennas, or other logical or arbitrary partition or in any combination thereof. The work load may be dynamic, allocating resources optimally in some sense to reduce operating costs, power, size or other appropriate metric or in any combination thereof. The system may enable hoteling (placing remote radio heads on multiple antenna masts). Processors may be synchronized using semaphores or equivalent synchronization methods on a multi-processor system. The allocation of computing resources can be dynamic using task queues and allocated to available processing elements according to a priority schedule. The processing system allows higher layer functions to be also used to accelerate higher layer protocol elements. The higher layer functions may be performed on more conventional general purpose processors (GPP) that may themselves be multi-processors. The processing system may include a GPP for control, scheduling and synchronization of processing tasks. The processing system may include antenna elements that are amplified and digitized and presented to the processing system and digitized signals are presented to an antenna element for transmission. Digitized data may be time stamped to align or identify data where time is required to perform the processing correctly. The processing system may include an ASIC that has multiple processing elements or a system that is comprised of multiple ASICs of this type to achieve a larger processing capability. The processing system may include a graphic processing unit (GPU) or general purpose graphics processing unit (GPGPU). The processing system may include an ADC and DAC interfaces for the source and destination signal streams or a plurality of ADC and DAC interfaces or other more direct interface to a RF upconversion/downconversion interface. The processing system may include dynamic spectrum awareness by performing operations required for the decision in allocating spectrum to maximize or minimize an objective function. The processing system may perform processing required to drive cognitive radio decisions. (e.g., sufficiently computationally intelligent radio resources and related computer-to-computer communications to detect user communications needs as a function of use context, and to provide radio resources and wireless services most appropriate to those needs). The processing system may compute metrics used in mesh network routing and computes optimal routes according to an objective function. The processing system may utilize a hierarchy of switching elements to create a switching fabric that allows communications between any pair wise processing element either directly or indirectly using the fabric. The processing system may use virtual machines for partitioning the processing between different service providers.

In order to further illustrate the principles and practice of the invention, a specific example of an FIR filter using the GPGPU in accordance with the presently preferred embodiments is shown below using the programming language CUDA which is a multiprocessor extension to C:

```
// cconv.cu
#include <stdio.h>
#include <cuda.h>
#include <cutil.h>
#include <cuda_runtime.h>
#define IMUL(a, b) (_mul24((a), (b)))
#define NH 100 // kernel length
#define NX 2048 // signal length
#define NLAGS (NX-NH)
#define BLOCK_SIZE 32 // CUDA block size
// GPGPU buffers, 2x because complex
_constant_float h[2*NH]; // kernel
_device_ float x[2*NX]; // input signal
_device_ float result[2*NLAGS]; // convolution output
// CUDA kernel which computes a single lag of a convolution
_global_ void cconv_lag( )
{
    /* compute which lag this thread needs to compute */
    const int lag2compute = IMUL(blockIdx.x,blockDim.x)+threadIdx.x;
    /* shared memory working buffer */
    _shared_float s_x[BLOCK_SIZE][2*NH];
    /* copy input samples from global memory to shared memory */
    for (int ii=0; ii<2*NH; ++ii)
      s_x[threadIdx.x[ii] = x[lag2compute+ii];
    /* complex convolution inner loop */
    float y[2] = {0.f}; // MAC output goes here
    float *signal = &s_x[threadIdx.x];
    for (int kk=0; kk<NH; ++kk) {
      a = signal[2*kk];
      b = signal[2*kk+1];
      c = h[2*kk];
      d = h[2*kk+1];
      // real MAC
      y[0] += a*c − b*d;
      // imag MAC
      y[1] += b*c + c*d;
    }
    /* store result */
    result[2*lag2compute] = y[0];
    result[2*lag2compute] = y[1];
}
int main(void)
{
    unsigned int hTimer;
    cutCreateTimer(&hTimer);
    /*
    * load data (omitted)
    */
    /* execute (and time) the complex convolution on the GPGPU */
  printf(“Running GPGPU computations...\n”);
  CUT_SAFE_CALL( cutResetTimer(hTimer) );
  CUT_SAFE_CALL( cutStartTimer(hTimer) );
  cconv_lag<<<1, NLAGS>>>0;
  CUDA_SAFE_CALL( cudaThreadSynchronize( ) );
  CUT_SAFE_CALL( cutStopTimer(hTimer) );
  double timerValue = cutGetTimerValue(hTimer);
  printf(“time : %f msec\n”, timerValue, REFDB_NTRACKS);
}
```

A portable system may include an RF up conversion and down conversion component interfacing to a digital processor and an antenna. a digital processor including a plurality of processing elements, a transducer for communications with the local environment that includes at least one of the following elements: a speaker and microphone; a digital interface for communications with another processor or storage device; a second wireless communications device; an analog to digital converter and a digital to analog converter for providing an analog interface; digital processing elements that can be programmed to support a plurality of communications waveforms; digital processing elements that can be programmed to support an image processing function.

The systems and methods of the invention provide one or more advantages including but not limited to one or more of, improved communications efficiency and reduced costs. While the invention has been described with reference to certain illustrative embodiments, those described herein are not intended to be construed in a limiting sense. For example, variations or combinations of features or materials in the embodiments shown and described may be used in particular cases without departure from the invention. Although the presently preferred embodiments are described herein in terms of particular examples, modifications and combinations of the illustrative embodiments as well as other advantages and embodiments of the invention will be apparent to persons skilled in the arts upon reference to the drawings, description, and claims.

We claim:

1. A communications processing system, comprising:
a plurality of functionally identical processing elements interconnected by shared memory interfaces;
a shared memory operably connected to a host General Purpose Processor (GPP) for one or more of, communications, and/or control of the processing elements;
wherein each processing element is connected to a local private memory, thereby increasing total memory bandwidth for the processing elements; and
a digital interface to one or more antennas.

2. The communications processing system of claim 1, wherein one or more processing elements are configurable for vector processing using multiple arithmetic units with common control for processing each element of a vector.

3. The communications processing system of claim 1, wherein one or more blocks of processing elements are configurable for vector processing using multiple arithmetic units with common control for processing each element of a vector.

4. The communications processing system of claim 1, wherein communications processing may be scheduled in any order, or in parallel, using common interface rules to accomplish the communications system operation, wherein the operation may be performed on separate processing elements or clusters of processing elements in any combination.

5. The communications processing system of claim 1, wherein processed data may be sourced or sunk through a separate interface in order for the processors to offload the GPP communications load or directly sunk or sourced by the GPP for simplicity of operation or in any combination.

6. The communications processing system of claim 1, wherein processed data may be directly sunk or sourced by the GPP.

7. The communications processing system of claim 1, wherein one or more of the processing elements further comprises an Application Specific Integrated Circuit (ASIC).

8. The communications processing system of claim 1, further comprising;
a digital interface for data to and/or from an antenna or a plurality of antennas using a high speed serial communications protocol.

9. The communications processing system of claim 1, further comprising;
an interface to a network using one or more standard interface for transporting data to and from the network.

10. The communications processing system of claim 1 wherein operating software may be downloaded to change the behavior of the processing system for improvements or new processing functions.

11. The communications processing system of claim 1, wherein the work load may be portioned according to one or more criteria selected from the group of: radio standard; service provide; antennas; or other logical partition;
thereby distributing the processing and dynamically allocating processing resources.

12. The communications processing system of claim 1, wherein the work load may be portioned according to one or more criteria selected from the group of: radio standard; service provide; antennas; or other logical partition;
thereby distributing the processing and statically allocating processing resources.

13. The communications processing system of claim 1, where the processing may be provided by a combination of one or more graphics processors (GPP) and general purpose graphics processors (GPGPU).

14. The communications processing system of claim 1, wherein the processors perform computations used for at least one of the following processing functions:
dynamic spectrum awareness for spectrum allocation optimization;
computing metrics for routing decisions between wireless nodes;
utilizing multiple antenna resources for improved performance;
computing metrics for improved system performance with multiple base stations.

15. A communication signal processing system comprising:
a plurality of processor elements, each further comprising local memory and an arithmetic unit, an interface for communications, and a control block that may control individual processing elements or clusters of processing elements;
a device for providing communication between the processor elements;
a host processor for programming and controlling the processor elements; and
an interface to one or more antennas.

16. The communication signal processing system of claim 15, further comprising one or more switching element interconnecting base band processing subsystems and one or more remote radio heads.

17. The communication signal processing system of claim 15, further comprising one or more switching element configured to route data among one or more processing subsystems.

18. The communication signal processing system of claim 15, further comprising one or more switching element configured to route data among one or more remote radio heads.

19. The communication signal processing system of claim 15, further comprising one or more switching element configured to route data among one or more processing subsystems for looping digital data for testing.

20. The communication signal processing system of claim 15, further comprising one or more switching element configured to route data among processing subsystems for providing redundancy for the processing subsystem resources.

21. A processing system comprising:
at least one GPP using an operating system;
at least one GPGPU for communications processing;
an interface to at least one radio resource;
an interface to at least one network.

22. The system of claim 21 wherein the GPP and its operating system are configured to establish virtual machines to partition service provider protection from outside an associated communications network.

23. The system of claim 21 wherein the GPP and its operating system are configured to establish virtual machines to partition service between two or more service provider applications for one or more of: Software as a Service (SaaS); Platform as a Service (PaaS); Infrastructure as a Service (IaaS).

24. The system of claim 21 wherein the GPP and its operating system are configured to establish virtual machines to partition service for supporting multiple radio standards simultaneously for one or more service providers.
